(19) United States
(12) Patent Application Publication
(10) Pub. No.: US 2003/0236360 A1
(43) Pub. Date: Dec. 25, 2003

(54) Blocked polyisocyanates

(76) Inventors: Christoph Gurtler, Koln (DE); Jan Mazanek, Koln (DE); Joachim Petzoldt, Monheim (DE); Thomas Klimmasch, Leverkusen (DE); Heino Muller, Leverkusen (DE)

Correspondence Address: BAYER POLYMERS LLC, 100 BAYER ROAD, PITTSBURGH, PA, 15205, US

(21) Appl. No.: 10/459,033

(22) Filed: Jun. 10, 2003

(30) Foreign Application Priority Data
Jun. 17, 2002 (DE) 10226925.4

(51) Int. Cl. C08F 283/04

(52) U.S. Cl. 525/453

(57) ABSTRACT

Blocking agents for polyisocyanates and their use in the preparation of blocked polyisocyanates and one-component systems. Blocked polyisocyanates and self-crosslinking one component baking systems are based on formula (I). Blocked polyisocyanates of formula (I) are produced from the reaction of polyisocyanates with secondary amines of formula (II). The blocked polyisocyanates may be used for preparing paints, inks, and other baking systems such as adhesives or elastomers and also as an additive in the vulcanization of rubbers.

### CROSS REFERENCE TO RELATED PARENT APPLICATIONS

The present patent application claims the right of priority under 35 U.S.C. §119 (a)-(d) of German Patent Applications No. 10226927.0, 10226931.9, 10226926.2, 10226925.4, and 10226924.6, all filed Jun. 17, 2002.

### BACKGROUND OF THE INVENTION

1. Field of the Invention

The present invention relates to blocking agents for polyisocyanates and to their use in the preparation of novel blocked polyisocyanates and, where appropriate, self-crosslinking one-component systems.

2. Description of the Related Art

The use of blocking agents for the temporary protection of isocyanate groups has been known for a long time. Blocked polyisocyanates are used for preparing heat-curable 1K PU baking systems which are stable on storage at room temperature. The blocked polyisocyanates are in that case mixed, for example, with hydroxyl-containing polyesters, polyacrylates, other polymers and also further constituents of paints and inks such as pigments, cosolvents or additives. Another way of obtaining baking varnishes which are stable on storage at room temperature is to block some of the isocyanate groups of polymers acquiring both blocked isocyanates and hydroxyl groups.

The principal compounds used to block polyisocyanates are ε-caprolactam, methyl ethyl ketoxime (butanone oxime), diethyl malonate, secondary amines and also triazole derivatives and pyrazole derivatives, as described in, for example, EP-A 0 576 952, EP-A 0 566 953, EP-A 0 159 117, U.S. Pat. No. 4,482,721, WO 97/12924 or EP-A 0 744 423.

Secondary amine blocking agents are described in EP-A 0 096 210. Although the blocking agents claimed therein include aralkyl-substituted amines, their use is not disclosed in the examples. The use of such amines in aqueous systems is not mentioned in EP-A 0 096 210.

The general formula of the blocking agents on p. 2, lines 20-24 or EP-A 0 096 210 allows for an infinitely large number of such diamines. On p. 3, lines 8 ff. of the same text, however, it is noted that not all secondary amines are suitable as compounds according to that invention. Page 5, lines 20-29 lists an extremely limited number of such diamines. The examples on pages 9 and 10, as well, relate only to dialkylamines such as diisopropylamine, substituted secondary cycloaliphatic amines such as substituted cyclohexylamine or cycloaliphatic N-heterocycles such as 2,2,4,6-tetramethylpiperidine. With the exception of diisopropylamine, these compounds are reacted with isocyanates at temperatures of at least 120° C., and so the person skilled in the art must assume that the elimination of these blocking agents, which is necessary for further reaction, does not take place until much higher temperatures are reached.

EP-A 0 178 398 claimed solid blocked isophorone diisocyanate as a curing agent for powder coating materials. Here again, aralkyl-substituted secondary amine blocking agents were claimed and tert-butyl-benzylamine was mentioned, albeit without a specific example. In EP-A 0 787 754 such blocking agents for selected polyisocyanates were claimed as curing agents for powder coating materials; tert-butyl-benzylamine or other aralkyl-substituted diamines, however, are not specified. Other liquid, solvent-containing preparations or aqueous or water-dilutable blocked polyisocyanates are mentioned in neither document.

The blocking agents employed most frequently for isocyanates are ε-caprolactam and butanone oxime. Whereas in the case of ε-caprolactam baking temperatures of around 160° C. are generally employed, blocked 1K baking varnishes for which butanone oxime has been used as blocking agent can be baked at temperatures which are from 10 to 20° C. lower. In many coating systems, however, the desired coating properties are no longer attained at these baking temperatures. And occasionally even these temperatures are found to be too high, so giving rise to a demand for baking systems which crosslink completely at lower temperatures than when using butanone oxime.

### BRIEF SUMMARY OF THE INVENTION

It is an object of the present invention, therefore, to find blocked polyisocyanates which have a lower crosslinking or baking temperature than butanone-oxime-blocked polyisocyanates. These systems should at the same time exhibit the same level of thermal yellowing, or less, on overbaking than butanone-oxime-blocked systems.

This object has been achieved with the blocked polyisocyanates of the invention and self-crosslinking one-component baking systems comprising them.

Normally, amine-type blocking agents on solvent-borne coating materials lead to a marked yellowing on baking. This is particularly the case with what is probably the foremost representative of the amine-type blocking agents, namely diisopropylamine. This effect is exacerbated in the case of what is called overbaking; in other words, with this blocking agent it is not possible to prepare coating materials which stand up to the criteria for overbake yellowing. In overbaking, the baked coating material is baked again at a temperature which is 20° C. higher. The overbaked test represents an important quality criterion for a coating system. The effects during baking of, for example, DIPA-blocked polyisocyanates are, for example, in described in “Polyurethane für Lacke und Beschichtungen/M. Bock, ed. Von Ulrich Zorll, Hannover 1999, Vincentz Verlag/Die Technologie des Beschichtens, page 32.

Surprisingly it has now been found that with arylalkyl blocking agents this effect does not occur. On the basis of the aromatic substructure of the blocking agent, even more severe yellowing in comparison to the purely aliphatic blocking agents would have been thought likely. What is found, however, is that blocked isocyanates blocked with aralkyl blocking agents can be baked in the presence of the usual catalysts at approximately 120° C. and give coatings having good mechanical properties and solvent resistances. The yellowing (see Table 1) is very low. Even on baking at 140° C./overbaking at 160° C. it does not exceed the value Δb=0.8 (see Table 1). These amines therefore differ markedly from the purely aliphatic amines, which typically have an of Δb=2 and so cannot be used for high-grade coating materials. The crosslinking of arylalkylamine-blocked isocyanates takes place at temperatures of 120° C. to give high-quality coating films. In the case of the similarly low-yellowing blocking agent dimethylpyrazole (DMP), in contrast, baking temperatures of 140° C. are needed. Accordingly it is possible to save on thermal energy for baking and/or to coat substrates for which baking temperatures of 140° C. are too high. A technical advantage is to be seen in this.

The present invention provides blocked polyisocyanates and self-crosslinking 1K baking systems based on polyurethane of the formula (I)

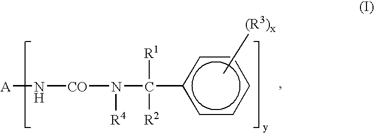

in which

A denotes the residue remaining after reaction of a polyisocyanate,

R¹, R², R³ may be identical or different and denote hydrogen, C₁-C₄-alkyl or cycloalkyl, hydrogen being preferred, and

R⁴ denote C₁-C₄-alkyl, C₆-C₁₀-cycloalkyl or C₇-C₁₄-aralkyl, preferably methyl, ethyl, isopropyl and tert-butyl, with particular preference tert-butyl,

x stands for the number 1, 2, 3, 4 or 5 and

y denotes a number from 1 to 8, preferably 2 to 6, with particular preference 2.5 to 4.0.

The invention also provides a process for preparing the blocked polyisocyanates of the formula (I) characterized in that polyisocyanates are reacted with secondary amines of the general formula (II)

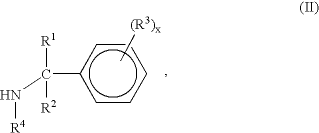

in which R¹, R², R³ and R⁴ and x have the meaning specified for formula (I).

Particular preference is given to using unsymmetrical substituted secondary amines of the formula (II), i.e. secondary amines having two different substituents.

The invention further provides for the use of the blocked polyisocyanates of the invention for preparing paints, inks and other baking systems such as adhesives or elastomers and also as an additive in the vulcanization of rubbers, and also provides articles made from these materials which are coated therewith.

### DETAILED DESCRIPTION OF THE INVENTION

As used herein, unless otherwise expressly specified, all of the numerical ranges, amounts, values and percentages such as those for amounts of materials, times and temperatures of reaction, ratios of amounts, values for molecular weight, and others in the following portion of the specification may be read as if prefaced by the word “about” even though the term “about” may not expressly appear with the value, amount or range.

Abbreviations for the following are used herein: butyl acetate (BA), dibutyl tin laurate (DBTL), propylene glycol monomethyl ether acetate (MPA), and solvent naphtha (SN).

As polyisocyanates for the purposes of the invention it is possible to use all known aliphatic, cycloaliphatic and aromatic polyisocyanates having an isocyanate content of 0.5 to 50%, preferably 3 to 30%, with particular preference 5 to 25% by weight, for example tetramethylene diisocyanate, cyclohexane 1,3- and 1,4-diisocyanate, hexamethylene diisocyanate (HDI), 1-isocyanato-3,3,5-trimethyl-5-isocyanato-methylcyclohexane (isophorone diisocyanate, IPDI), methylenebis(4-isocyanatocyclohexane), tetramethylxylylene diisocyanate (TMXDI), triisocyanatononane.

Also suitable are aromatic polyisocyanates such as toluene diisocyanate (TDI), diphenylmethane 2,4′- and/or 4,4′-diisocyanate (MDI), triphenylmethane 4,4′-diisocyanate, naphthylene 1,5-diisocyanate.

Preferred suitability is possessed by polyisocyanates containing heteroatoms in the radical or residue containing the isocyanate groups. Examples thereof are polyisocyanates containing carbodiimide groups, allophanate groups, isocyanurate groups, urethane groups and biuret groups. Especially suitable for the invention are the known polyisocyanates which are used principally in the preparation of coating materials, examples being modification products of the abovementioned simple polyisocyanates, especially of hexamethylene diisocyanate or of isophorone diisocyanate, that contain biuret, isocyanurate or uretdione groups. Also suitable are low molecular weight polyisocyanates containing urethane groups, such as may be obtained by reacting IPDI or TDI employed in excess with simple polyhydric alcohols of the molecular weight range 62 to 300, in particular with trimethylolpropane or glycerol.

Suitable polyisocyanates are, in addition, the known prepolymers containing terminal isocyanate groups, such as are obtainable in particular by reacting the abovementioned simple polyisocyanates, preferably diisocyanates, with substoichiometric amounts of organic compounds containing at least two isocyanate-reactive functional groups. In these known prepolymers the ratio of isocyanate groups to NCO-reactive hydrogen atoms is 1.05:1 to 10:1, preferably 1.1:1 to 3:1, the hydrogen atoms coming preferably from hydroxyl groups. The nature and proportions of the starting materials used in the preparation of NCO prepolymers are preferably chosen so that the NCO prepolymers preferably have an average NCO functionality of 2 to 3 and a number-average molar mass of 500 to 10000, preferably 800 to 4000.

Further suitable polyisocyanates for the purposes of the invention are those polyurethane-, polyester- and/or polyacrylate-based polymers and also, where appropriate, their mixtures that contain free isocyanate groups and in which only some of the free isocyanate groups are reacted with the blocking agents of the invention while the remainder are reacted with an excess of hydroxyl-containing polyesters, polyurethanes and/or polyacrylates and also, where appropriate, mixtures thereof to give a polymer which contains free hydroxyl groups and which, on heating to appropriate baking temperatures, crosslinks without the addition of further isocyanate-reactive groups (self-crosslinking one-component baking systems).

Naturally, the said polyisocyanates may also be used as mixtures with one another or else with other crosslinkers such as with melamine resins for preparing paints, inks and other formulations.

The blocked polyisocyanates of the invention can be prepared by methods which are known per se. For example, one or more polyisocyanates can be introduced initially and the blocking agent can be metered in with stirring (over about 10 minutes, for example). Stirring is continued until free isocyanate is no longer detectable. It is also possible to block one or more polyisocyanates with a mixture of two or more blocking agents.

Preference is given to preparing the blocked polyisocyanates of the invention in solvents. In contrast to the amines used conventionally, unsymmetrical secondary amines offer the advantage, in contradistinction to symmetrical secondary amines, that the solutions of the blocked polyisocyanates prepared therewith exhibit a reduced crystallisation tendency. It is therefore possible to prepare solutions of blocked polyisocyanates having a higher solids content, for the areas of coil coating, high-solids coating materials or automotive topcoat materials, for example. Suitable solvents may be selected from organic solvents. Suitable solvents include all known solvents possessing no isocyanate-reactive groups, examples being xylene, N-methylpyrrolidone, butyl acetate, relatively high-boiling aliphatics and/or aromatics, butyl diglycol acetate, acetone, etc.

In the preparation of the polyisocyanates of the invention it is also possible to use catalysts, cosolvents and other auxiliaries and additives.

The blocked polyisocyanates of the invention are used as self-crosslinking one-component baking systems. They are added to formulations to prepare binders for coating materials, for paints, inks and other baking systems such as adhesives and elastomers, and as crosslinkers (component) for polyol components. The polyisocyanates of the invention are, as described above, either self-crosslinking polymers or else can be used as crosslinkers for polyol components. Suitable polyol components, which may also be used in the form of mixtures, include the following:

Polyhydroxypolyesters, polyhydroxypolyethers or hydroxyl-containing addition polymers, examples being the polyhydroxypolyacrylates known per se. The compounds generally have a hydroxyl number of from 20 to 200, preferably from 50 to 130, based on products in 100% form.

The polyhydroxyl polyacrylates are conventional copolymers of styrene with simple esters of acrylic acid and/or methacrylic acid, the hydroxyl groups being introduced with the use of hydroxyalkyl esters, such as, for example, the 2-hydroxyethyl, 2-hydroxypropyl, 2-, 3- or 4-hydroxybutyl esters of these acids.

Suitable polyetherpolyols are the ethoxylation and/or propoxylation products, known per se from polyurethane chemistry, of suitable starter molecules with a functionality of 2 to 4, such as water, ethylene glycol, propanediol, trimethylolpropane, glycerol and/or pentaerythritol, for example.

Examples of suitable polyester polyols are, in particular, the reaction products, known per se in polyurethane chemistry, of polyhydric alcohols, for example of alkanepolyols of the type exemplified with excess amounts of polycarboxylic acids and/or polycarboxylic anhydrides, especially dicarboxylic acids and/or dicarboxylic anhydrides. Examples of suitable polycarboxylic acids and polycarboxylic anhydrides are adipic acid, phthalic acid, isophthalic acid, phthalic anhydride, tetrahydrophthalic anhydride, hexahydrophthalic anhydride, maleic acid, maleic anhydride, the Diels-Alder adducts thereof with cyclopentadiene, fumaric acid or dimeric and/or trimeric fatty acids. In the preparation of the polyester polyols it is of course possible to use any desired mixtures of the polyhydric alcohols exemplified or any desired mixtures of the exemplified acids and/or acid anhydrides.

The polyester polyols are prepared by known methods, as described, for example, in Houben-Weyl, Methoden der organischen Chemie, Volume XIV/2, G. Thieme-Verlag, 1963, pages 1 to 47. The hydrophilic modification of these polyhydroxyl compounds that may be necessary takes place in accordance with methods which are known per se, such as are described, for example, in EP-A 0 157 291 or EP-A 0 427 028.

The preparation of the paints, inks and other formulations using the polyisocyanates of the invention takes place in accordance with methods known per se. Besides the polyisocyanates and polyols, the formulations may be admixed with customary additives and other auxiliaries (e.g. pigments, fillers, levelling agents, defoamers, catalysts) in amounts readily determinable by the person skilled in the art.

The blocked polyisocyanates of the invention are used for preparing baking varnishes, for example for industrial coating and in automotive OEM finishing. For this purpose the coating compositions of the invention may be applied by knife coating, dipping, spray applications such as compressed-air spraying or airless spraying, and also by electrostatic application, for example high-speed rotational bell application. The dry film thickness may be, for example, from 10 to 120 μm. The dried films are cured by baking in temperature ranges from 90 to 160° C., preferably 110 to 140° C., with particular preference at 120 to 130° C.

As Table 1 indicates, the novel blocking agent at a baking temperature of 120° C. exhibits properties comparable with those of a polyisocyanate which has been blocked with DMP and baked at 140° C.

Under these conditions, the inventively blocked polyisocyanates blocked with the blocking agent tert-butyl-benzylamine at the same time exhibit a thermal overbake behaviour comparable with that of what was hitherto the best blocking agent in this respect, namely DMP, on a solvent-borne basecoat (see comparison with DMP-blocked polyisocyanate). Accordingly, better overbake yellowings are obtained than with butanone-oxime-blocked products.

### EXAMPLES

Particle sizes were determined by laser correlation spectroscopy (LSC).

### Example 1

(Preparation of a Solvent-Containing Polyisocyanate Crosslinker)

117 g (0.6 eq) of a commercial isocyanurate-containing paint polyisocyanate based on 1,6-diisocyanatohexane (HDI) (Desmodur® N3300, Bayer A G), having an NCO content of 21.4% by weight, a viscosity at 23° C. of about 3000 mPas and a functionality of about 3.5, and 98 g (0.6 eq) of benzyl-tert-butylamine are reacted in 215 g of butyl acetate. The temperature rises to about 40° C. The reaction is over in less than two hours. The blocked NCO value is 5.86%. The blocked isocyanate obtained in this way was used for producing coating films.

| | | |
|---|---|---|
| Desmophen ® 870 (Bayer AG), 70% in BA | 8.9 | g |
| Blocked polyisocyanate from Example 1, 50% in BA | 99.8 | g |
| Baysilone ® OL 17 (Bayer AG), 10% in MPA | 1.1 | g |
| Modaflow ® (Solutia Inc.), 1% in MPA | 1.1 | g |
| Tinuvin ® 292 (Ciba AG, Lampertheim), 10% in MPA | 10.5 | g |
| Tinuvin ® 1130 (Ciba AG, Lampertheim), 10% in MPA | 21.0 | g |
| K-KAT 348 (King Industries), 25% in MPA | 6.3 | g |
| MPA/SN 100 (1:1) | 1.3 | g |
| total | 220.0 | g |
| Solids content: 50.0% | | |

Desmophen® A 870: Hydroxyl-functional polyacrylate resin supplied in butyl acetate

Baysilone® OL 17: Silicone fluid

Modaflow®: Flow modifier

Tinuvin® 292: UV stabilizer

Tinuvin® 1130: Anti-oxidant/UV absorber

K-KAT 348: Metal carboxylate catalyst

Results: The polyisocyanate blocked with the blocking agent of the invention is compared with a polyisocyanate VP LS 2253 (Bayer A G), which is a dimethylpyrazole-blocked polyisocyanate (Desmodur® N 3300, Bayer A G, in solution in MPA/solvent naphtha).

TABLE 1
Comparison of tert-butyl-benzyl-amine-blocked polyisocyanates with
3,5-dimethylpyrazole-blocked polyisocyanates:

| | | Comparative |
|---|---|---|
| | | Example: |
| Designation | Example 1 | VP LS 2253 |
| Composition | 27.2% N 3300 | 49.9% N 3300 |
| | 22.8% N-benzyl-tert- | 25.1% DMP |
| | butylamine | 8.3% MPA |
| | 50.00% butyl acetate | 16.7% SN 100 |
| Supply form | 50% in BA | 75% in MPA/SN |
| | | 100 (8:17) |
| PIC basis | N 3300 | N 3300 |
| Blocking agent | N-benzyl-tert-butylamine | 3,5- |
| | | dimethylpyrazole |
| Polyol | A 870 | A 870 |
| Catalyst | 1.5 K-Kat 348 | 1.0% DBTL |
| Solids content at spray | 50.0 | 50.0 |
| [%] | | |
| Efflux time ISO 5 cup | 21 | 22 |
| [s] | | |
| Visual assessment of | clear | clear |
| the coating material | | |

| | Baking conditions | | |
|---|---|---|---|
| | 30′ 120° C. | 30′ 140° C. | 30′ 140° C. |
| Visual assessment of | satisfactory | satisfactory | satisfactory |
| the coating film | | | |
| Pendulum damping, | 128 | 137 | 129 |
| König method | 179 | 192 | 181 |
| [swings][s] | | | |
| Solvent resistance | | | |
| (X/MPA/EA/Ac) | | | |
| [Rating]¹⁾ | | | |
| 1 min. | 1123 | 0023 | 1123 |
| 5 min. | 2244 | 2244 | 2244 |
| Erichsen cupping | 10.0 | 9.5 | 3.5 |
| [mm] | | | |
| Chemical resistance | | | |
| [° C.] (gradient oven) | | | |
| tree resin | 40 | 42 | 36 |
| brake fluid | 36 | 36 | 36 |
| pancreatin, 50% | 36 | 36 | 36 |
| NaOH, 1% | 47 | 49 | 46 |
| H₂SO₄, 1% | 43 | 45 | 43 |
| FAM*, 10 min. | 0 | 0 | 2 |
| [Rating]¹⁾ | | | |
| Scratch resistance | | | |
| (Amtec Kistler | | | |
| Laboratory washing | | | |
| unit)²⁾ | | | |
| Initial gloss 20° | 91.4 | 91.4 | 91.3 |
| Loss of gloss (Δgloss) | 12.1 | 11.7 | 14.5 |
| after 10 wash cycles | | | |
| 20° | | | |
| Relative residual | 86.8 | 87.2 | 84.1 |
| gloss [%] | | | |
| Thermal yellowing | | | |
| Clearcoat on SM | | | |
| basecoat | | | |
| Initial yellowing [b] | 3.6 | 3.5 | 3.3 |
| Overbake yellowing at | | | |
| 30′ 140° C. | | | |
| [Δb] | 0.5 | | 0.5 |
| Overbake yellowing at | | | |
| 30′ 160° C. | | | |
| [Δb] | | 0.8 | 0.5 |

¹⁾0—good; 5—poor
*FAM ≈ standard-grade gasoline

### Example 2

(Preparation of a Solvent-Containing Polyisocyanate Crosslinker)

24.7 g (0.07 eq) of a commercial isocyanurate-containing paint polyisocyanate based on 1-isocyanato-3,5,5-trimethyl-5-isocyanatomethylcyclohexane (isophorone diisocyanate, IPDI) (commercial product Desmodur® Z 4470 from Bayer A G), having an NCO content of 11.9% by weight, a viscosity at 23° C. of about 600 mPas and 11.4 g (0.07 eq) of benzyl-tert-butylamine are reacted in 15.5 g of butyl acetate. The temperature rises to about 40° C. The reaction is over in less than two hours. The blocked NCO value is 5.7%. The blocked isocyanate obtained in this way was used for producing coating films.

### Example 3

(Preparation of a Solvent-Containing Polyisocyanate Crosslinker)

117 g (0.6 eq) of an isocyanurate-containing paint polyisocyanate based on 4,4′-diisocyanatodicyclohexylmethane (Desmodur® W, Bayer A G, preparation described below), having an NCO content of 15.1 % by weight (solid, melting point about 100° C.) and a functionality of about 3.5, and 98 g (0.6 eq) of benzyl-tert-butylamine are reacted in 215 g of butyl acetate. The temperature rises to about 40° C. The reaction is over in less than two hours. The blocked NCO value is 4.47%. The blocked isocyanate obtained in this way was used for producing coating films.

The trimer of 4,4′-diisocyanatodicyclohexylmethane is prepared as follows: 2620 g of 4,4′-diisocyanatodicyclohexylmethane are trimerized at 60° C. with 6 g of a 10% strength solution of trimethylbenzylammonium hydroxide catalyst dissolved in 2-ethylhexanol:methanol=5:1 at a temperature of from 60 to 75° C. until the NCO content is 26.8%. To end the trimerization reaction, 0.5 g of bis(2-ethylhexyl) phosphate is added. The clear crude solution is then admixed with 130 g of an isocyanurate polyisocyanate based on diisocyanato hexane (HDI), obtained according to Example 12 of EP-A 0 330 966, and monomeric 4,4′-diisocyanatodicyclohexylmethane is separated off by thin-film distillation at 200° C./0.15 mbar. A pale, slightly yellowish solid resin is obtained having an NCO content of 15.1%, a melting point of about 100° C., a monomeric diisocyanate content of <0.2% and an average NCO functionality, calculated from the NCO content, of 3.5. The solid resin is then dissolved to a concentration of 70% in butyl acetate.

### Example 4

(Comparative Example I)

The procedure described in Example 2 was repeated but using butanone oxime instead of N-benzyl-tert-butylamine. The dispersion obtained had the following properties:

| | |
|---|---|
| Solids content: | 38% |
| pH: | 8.5 |
| Viscosity (23° C.) | 4000 mPas |
| Particle size (LCS) | 42 nm |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Blocked polyisocyanates of the formula (I) 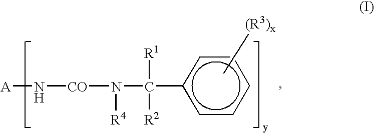
in which
A denotes the residue remaining after reaction of a polyisocyanate,
R¹, R², R³ may be identical or different and denote hydrogen, C₁-C₄-alkyl or cycloalkyl, and
R⁴ denote C₁-C₄-alkyl, C₆-C₁₀-cycloalkyl or C₇-C₁₄-aralkyl,
x stands for the number 1, 2, 3, 4 or 5 and
y denotes a number from 1 to 8.

2. Process for preparing the blocked polyisocyanates according to claim 1, wherein polyisocyanates are reacted with secondary amines of the formula (II)

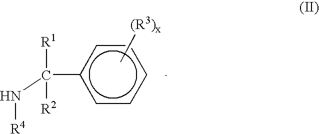

3. Blocked polyisocyanates according to claim 1, wherein N-benzyl-tert-butylamine is used as secondary amine.

4. Blocked polyisocyanates according to claim 1, wherein the blocked polyisocyanates are prepared in organic solvents.

5. Method for preparing products comprising one of paints, inks, adhesives and elastomers, comprising adding blocked polyisocyanates according to claim 1 to a formulation.

6. Method according to claim 5, wherein the products produced are self-crosslinking systems.

7. Method according to claim 5, wherein the products produced are baking systems.

8. Method for crosslinking polyol components, comprising
a) adding blocked polyisocyanates according to claim 1 to the polyol components; ands
b) heating at a temperature sufficient to deblock the polyisocyanates.

9. The blocked polyisocyanates of claim 1, wherein
R¹, R² and R³ denote hydrogen,
R⁴ denotes tert-butyl, and
y denotes a number from 2 to 6.

10. The blocked polyisocyanates of claim 1, wherein y denotes a number from 2.5 to 4.0.
